(19) United States
(12) Patent Application Publication
(10) Pub. No.: US 2009/0150205 A1
(43) Pub. Date: Jun. 11, 2009

(54) CAPITAL ALLOCATION SYSTEMS AND METHODS

(75) Inventors: Roger L. Tobin, Arlington, MA (US); Gregory K. Evans, Ringoes, NJ (US); Mariano J. Legaz, Califon, NJ (US); Hui Liu, Lexington, MA (US); Daniel J. McCauley, Basking Ridge, NJ (US); Sammy J. Thomas, Ridgewood, NJ (US); Rina R. Schneur, Lexington, MA (US)

Correspondence Address: VERIZON;PATENT MANAGEMENT GROUP, 1320 North Court House Road, 9th Floor, ARLINGTON, VA, 22201-2909, US

(73) Assignees: Verizon Corporate Services Group Inc., Basking Ridge, NJ (US); Verizon Services Organization Inc., Irving, TX (US); Verizon Corporate Services Corp., Arlington, VA (US)

(21) Appl. No.: 11/951,967

(22) Filed: Dec. 6, 2007

(51) Int. Cl. G06Q 10/00

(52) U.S. Cl. 705/8

(57) ABSTRACT

In an exemplary system, a capital allocation subsystem is selectively and communicatively coupled to a project screening subsystem. The project screening subsystem is configured to aggregate project data corresponding to a plurality of potential projects within an organization and communicate the project data to the capital allocation subsystem. The capital allocation subsystem is configured to facilitate input of one or more constraints on allocation of capital among the potential projects and adjust at least one of the constraints to select a subset of the potential projects for the allocation of the capital such that a return on the capital is optimized.

### BACKGROUND INFORMATION

Almost all organizations, including corporations and other enterprises, have limited financial resources. Capital planning and allocation is therefore an essential component of business strategy and plays a large part in the success or demise of an organization.

In organizations with a large portfolio of business and capital projects across multiple business units or divisions, the process of capital allocation among those projects is difficult and complex. Competing interests, project interdependencies, and unknown variables inhibit the ability of organization planners to allocate capital among the various business units in the most efficient and productive manner.

Many approaches to organization-wide capital allocation are based on either an organization solution (e.g., centralized planning, funding, and implementation) or deal only at the macro, business unit level of planning. Accordingly, capital funds can only be allocated across business units and not across projects. This limits the ability of the organization to balance returns with project risks.

### BRIEF DESCRIPTION OF THE DRAWINGS

The accompanying drawings illustrate various implementations and are a part of the specification. The illustrated implementations are merely examples and do not limit the scope of the disclosure. Throughout the drawings, identical or similar reference numbers designate identical or similar elements.

FIG. 1 illustrates an exemplary organizational structure of a business organization according to principles described herein.

FIG. 2 shows that one or more projects may be associated with each business unit according to principles described herein.

FIG. 3 illustrates an exemplary capital allocation system according to principles described herein.

FIG. 4 illustrates an exemplary project screening subsystem according to principles described herein.

FIG. 5 illustrates an exemplary capital allocation subsystem according to principles described herein.

FIG. 6 illustrates an exemplary method of screening project data for input into a capital allocation subsystem according to principles described herein.

FIG. 7A illustrates an exemplary landing page for a project data input template according to principles described herein.

FIG. 7B illustrates an exemplary input data graphical user interface (“GUI”) according to principles described herein.

FIG. 7C shows an exemplary GUI configured to display a summary of errors found within an exemplary set of input project data according to principles described herein.

FIG. 7D illustrates an exemplary GUI configured to display a detailed errors and warning report that may be generated after project data is screened for errors according to principles described herein.

FIG. 8A illustrates an exemplary landing page for a project data aggregation template according to principles described herein.

FIG. 8B illustrates an exemplary GUI showing combined project data corresponding to two distinct business units according to principles described herein.

FIG. 9A illustrates an exemplary landing page for a capital allocation tool according to principles described herein.

FIG. 9B illustrates an exemplary allocation configuration GUI according to principles described herein.

FIG. 9C illustrates a results page configured to display the results of a generated allocation scenario according to principles described herein.

FIG. 9D illustrates an exemplary output report menu GUI according to principles described herein.

FIG. 9E illustrates an exemplary summary report that may be generated and displayed by capital allocation subsystem according to principles described herein.

FIG. 9F illustrates an exemplary detailed project listing report that may be generated and displayed by capital allocation subsystem according to principles described herein.

FIG. 9G shows the exemplary allocation configuration GUI of FIG. 9B wherein two constraints have been input by a user according to principles described herein.

FIG. 9H illustrates an exemplary dependency analysis GUI for a particular project according to principles described herein.

FIG. 10 is a diagram illustrating an exemplary process used to allocate capital among a number of potential projects according to principles described herein.

FIGS. 11A-11B illustrate exemplary GUIs that may be displayed within a boundary analysis tool according to principles described herein.

FIG. 12 illustrates an exemplary allocation scenario comparison GUI configured to facilitate comparison of two or more allocation scenarios according to principles described herein.

FIG. 13 illustrates an exemplary comparison report that may be generated to compare two or more allocation scenarios according to principles described herein.

FIG. 14 illustrates an exemplary method of allocating capital among potential projects based on project data provided by project screening subsystem according to principles described herein.

### DETAILED DESCRIPTION OF PREFERRED EMBODIMENTS

Exemplary capital allocation systems and methods are described herein. The systems and methods described herein facilitate efficient and optimal capital allocation among multiple projects that may be spread among multiple business units within an organization.

As used herein, the term “project” refers to any undertaking, job, product, campaign, task, group of projects, or other activity or combination thereof associated with a particular organization and/or business unit within the organization. For example, a project may include one or more phases of taking a particular product to market. The term “potential project” will be used to refer to a project being considered for capital allocation.

In an exemplary system, a capital allocation subsystem is selectively and communicatively coupled to a project screening subsystem. The project screening subsystem is configured to facilitate aggregation of project data corresponding to a plurality of potential projects within an organization and communicate the project data to the capital allocation subsystem. The capital allocation subsystem is configured to facilitate input of one or more constraints on capital allocation among the potential projects and adjust at least one of the constraints to select a subset of the potential projects for capital allocation such that a return on the capital is optimized. As used herein, “return on capital” refers to value received from capital allocation as measured using any suitable metric such as, but not limited to, net present value (“NPV”), cash flow return on investment (“CFROI”), profitability index (“PI”), revenue, operating income (“OI”), and earnings before interest, taxes, depreciation, and amortization (“EBITDA”).

Hence, the systems and methods described herein may help organizations to develop and manage a potentially large portfolio of projects spread across multiple business units. Long term financial returns may be more effectively balanced with short term earnings and cash flow impact. Optimized financial returns may be realized across the entire organization, while at the same time highlighting business unit-level responsibility for plans and results.

Exemplary implementations of capital allocation systems and methods will now be described in more detail with reference to the accompanying drawings.

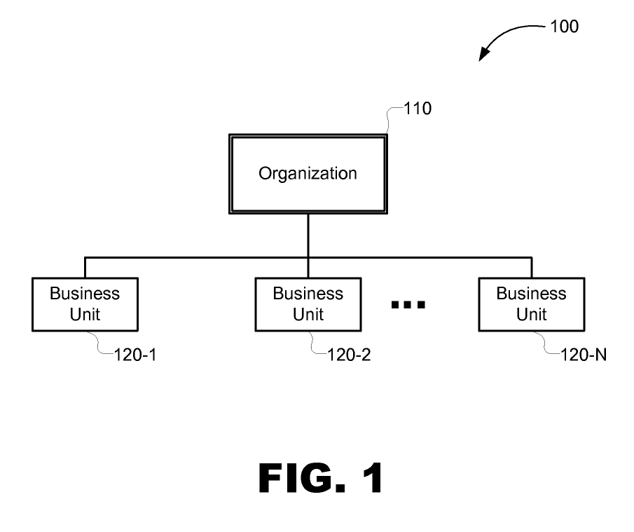

FIG. 1 illustrates an exemplary organizational structure 100 of a business organization 110. As shown in FIG. 1, a business organization 110 (or simply “organization 110”) may include a plurality of business units 120-1 through 120-N (collectively “business units 120”).

An exemplary organization 110 may include, but is not limited to, one or more corporations, enterprises, partnerships, business organizations, or any other organized group or combination thereof. Organization 110 may include various managers, capital planners, and/or other personnel to manage, operate, and oversee operations of business units 120.

Business units 120 may include, but are not limited to, various divisions, departments, entities, subsidiaries, and/or other sub-groups of organization 110. For example, one or more of the business units 120 may include a particular product division or subsidiary, customer billing department, sales department, accounting department, marketing department, inventory department, ordering department, repairs department, procurement department, and/or research and development teams. Each business unit 120 may also include one or more managers, capital planners, employees, and/or other personnel to manage and operate various projects or other undertakings at the business unit level. Moreover, each business unit 120 may manage one or more additional business units (not shown).

The number of business units 120 within organization 110 may vary as may serve a particular application. To illustrate, a large organization 110 may include ten or more business units 120.

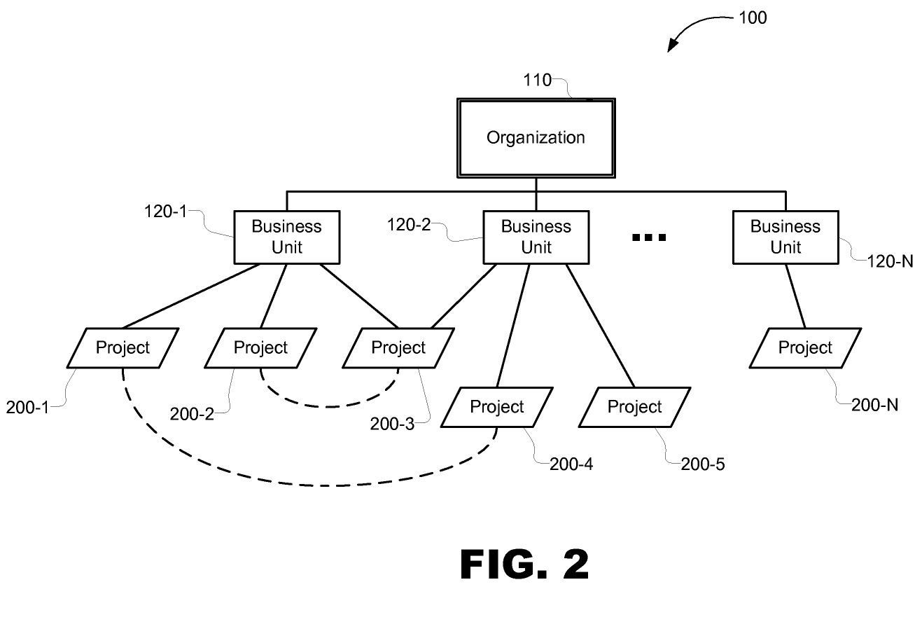

FIG. 2 shows that one or more projects (e.g., 200-1 through 200-N, collectively referred to as 200) may be associated with each business unit 120. For example, FIG. 2 shows that projects 200-1 through 200-3 may be associated with business unit 120-1, projects 200-3 through 200-5 may be associated with business unit 120-2, and project 200-N may be associated with business unit 120-N. Projects 200 may also be associated with multiple business units 120. For example, project 200-3 is associated with business units 120-1 and 120-2.

In some examples, two or more projects 200 may be dependent on one another or otherwise interrelated. Interdependent projects in FIG. 2 are connected by dashed lines. For example, projects 200-1 and 200-4 are dependent on one another, and projects 200-2 and 200-3 are also dependent on one another. Projects may be interdependent in that one project cannot be undertaken without the other (e.g., project 200-1 cannot be undertaken unless project 200-4 is undertaken). As shown in FIG. 2, projects may be interdependent within the same business unit 120 (e.g., projects 200-2 and 200-3) or across different business units 120 (e.g., projects 200-1 and 200-4).

In some examples, each project 200 requires capital in order to function, operate, or otherwise be carried out. However, there is often a limit to the amount of capital that may be allocated to projects 200. Hence, personnel within organization 110 and/or business units 120 periodically conduct capital allocation sessions wherein potential projects are evaluated to determine whether and/or how much capital should be allocated thereto.

However, if organization 110 has a relatively large portfolio of projects 200 spread across multiple business units 120, the process of capital allocation among those projects 200 is difficult and complex. Competing interests, project interdependencies, and unknown variables inhibit the ability of organization planners to allocate capital among the various potential projects in the most efficient and productive manner.

Typical capital allocation techniques include formulating an optimization problem with an objective function to maximize (e.g., NPV, CFROI, etc.), with constraints on capital expenditures and other financial metrics, and constraints that enforce project dependencies. However, these techniques are not well suited for determining budget levels because, given a target budget constraint, they exhaust the entire budget as long as there is a positive return, no matter how small the return may be. If a potential project with the next best return will not fit within the budget, the techniques will use up the budget by allocating capital to smaller projects with inferior returns that fit within the budget constraint. Some projects with potentially higher returns than those selected may therefore not be chosen for capital allocation. Hence, the marginal return is not as high as it could be with slightly different constraint values. The budget constraints and constraints on other financial metrics are actually “soft” and indicate a target or desired neighborhood, whereas the project dependency constraints are “hard” and must be met exactly.

To this end, the systems and methods described herein provide more efficient and flexible capital allocation among projects spread across a plurality of business units 120 within an organization 110.

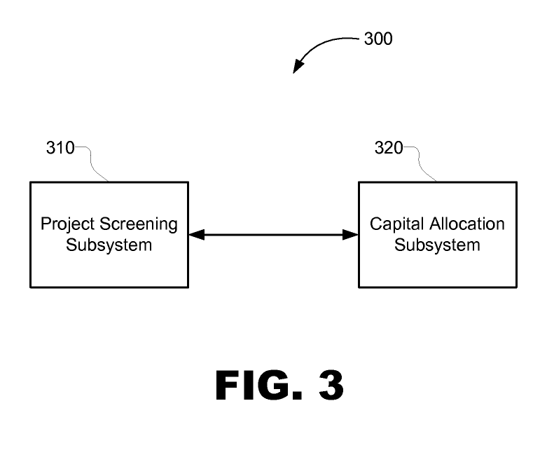

FIG. 3 illustrates an exemplary capital allocation system 300. As shown in FIG. 3, capital allocation system 300 (or simply “system 300”) may include a project screening subsystem 310 selectively and communicatively coupled to a capital allocation subsystem 320.

Project screening subsystem 310 and capital allocation subsystem 320 may communicate using any communication platforms and technologies suitable for transporting data, including known communication technologies, devices, media, and protocols supportive of data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Short Message Service (“SMS”), Multimedia Message Service (“MMS”), socket connections, signaling system seven (“SS7”), Ethernet, in-band and out-of-band signaling technologies, and other suitable communications networks and technologies.

In some examples, project screening subsystem 310 and capital allocation subsystem 320 may communicate via one or more networks, including, but not limited to, wireless networks, broadband networks, closed media networks, cable networks, satellite networks, the Internet, intranets, local area networks, public networks, private networks, optical fiber networks, and/or any other networks capable of carrying data and communications signals between project screening subsystem 310 and capital allocation subsystem 320.

In some examples, one or more components of system 300 may include any computer hardware and/or instructions (e.g., software programs including, but not limited to spreadsheet software (e.g., Microsoft Excel, etc.), optimization engines (e.g., Frontline Solver Engines, etc.), programming software (e.g., Visual Basic, etc.)), or combinations of software and hardware, configured to perform the processes described herein. In particular, it should be understood that one or more components of system 300 may be implemented on one physical computing device or may be implemented on more than one physical computing device. For example, project screening subsystem 310 and capital allocation subsystem 320 may be implemented on one physical computing device or on more than one physical computing device. Accordingly, system 300 may include any one of a number of computing devices, and may employ any of a number of computer operating systems, including, but by no means limited to, versions and/or varieties of the Microsoft Windows®, UNIX, Macintosh®, and Linux® operating systems.

Accordingly, one or more processes described herein may be implemented at least in part as computer-executable instructions, i.e., instructions executable by one or more computing devices, tangibly embodied in a computer-readable medium. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

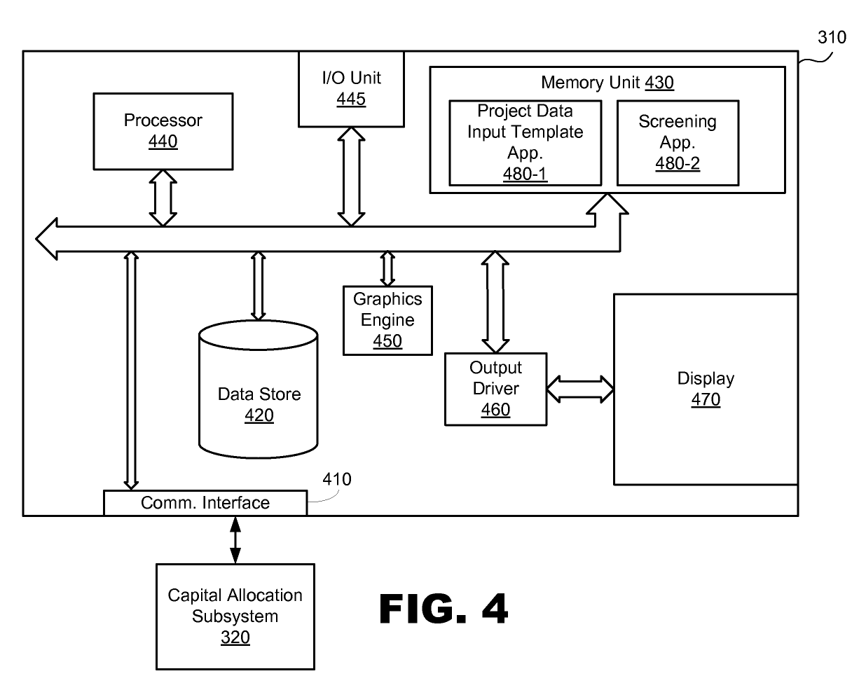

FIG. 4 illustrates an exemplary project screening subsystem 310. As will be described in more detail below, project screening subsystem 310 is configured to facilitate compilation of project data describing potential projects to be considered for capital allocation. Project screening subsystem 310 may be configured to interact with various peripherals such as a terminal, keyboard, mouse, display screen, printer, stylus, input device, output device, or any other apparatus.

As shown in FIG. 4, project screening subsystem 310 may include a communication interface 410, data store 420, memory unit 430, processor 440, input/output unit 445 (“I/O unit 445”), graphics engine 450, output driver 460, and display 470 communicatively connected to one another. While an exemplary project screening subsystem 310 is shown in FIG. 4, the exemplary components illustrated in FIG. 4 are not intended to be limiting. Indeed, additional or alternative components and/or implementations may be included within the project screening subsystem 310.

Communication interface 410 may be configured to send and receive data to/from capital allocation subsystem 320. Communication interface 410 may include any device, logic, and/or other technologies suitable for transmitting and receiving project data. The communication interface 410 may be configured to interface with any suitable communication media, protocols, formats, platforms, and networks, including any of those mentioned herein.

Data store 420 may include one or more data storage media, devices, or configurations and may employ any type, form, and combination of storage media. For example, the data store 420 may include, but is not limited to, a hard drive, network drive, flash drive, magnetic disc, optical disc, or other non-volatile storage unit. Data, including project data, may be temporarily and/or permanently stored in the data store 420.

Memory unit 430 may include, but is not limited to, FLASH memory, random access memory (“RAM”), dynamic RAM (“DRAM”), or a combination thereof. In some examples, as will be described in more detail below, applications executed by the project screening subsystem 310 may reside in memory unit 430.

Processor 440 may be configured to control operations of components of the project screening subsystem 310. Processor 440 may direct execution of operations in accordance with computer-executable instructions such as may be stored in memory unit 430. As an example, processor 440 may be configured to process input project data, including screening the project data for errors and preparing the project data for uploading to capital allocation subsystem 320.

I/O unit 445 may be configured to receive user input and provide user output and may include any hardware, firmware, software, or combination thereof supportive of input and output capabilities. For example, I/O unit 445 may include one or more devices for inputting project data and may include, but is not limited to, a keyboard or keypad, a touch screen component, a mouse or other pointer device, etc.

As instructed by processor 440, graphics engine 450 may generate graphics, which may include tables, reports, charts, graphical spreadsheets, and/or any other graphical user interface (“GUI”). The output driver 460 may provide output signals representative of the graphics generated by graphics engine 450 to display 470. The display 470 may then present the graphics for experiencing by the user.

One or more applications (e.g., 480-1 and 480-2, collectively referred to as applications 480) may be executed by the project screening subsystem 310. The applications 480, or application clients, may reside in memory unit 430 or in any other area of the project screening subsystem 310 and be executed by the processor 440. Each application 480 may correspond to a particular feature or capability of the project screening subsystem 310. For example, illustrative applications 480 may include a project data input template application 480-1 configured to facilitate input of project data and a screening application 480-2 configured to screen the input project data for errors. Additional or alternative applications 480 may be included within project screening subsystem 310 as may serve a particular application.

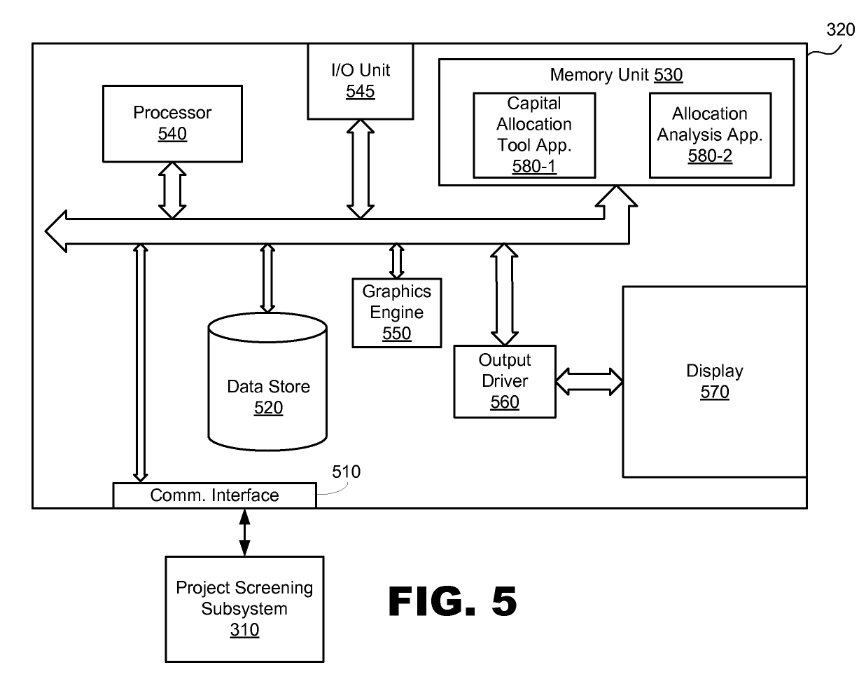

FIG. 5 illustrates an exemplary capital allocation subsystem 320. As will be described in more detail below, capital allocation subsystem 320 is configured to facilitate analysis of project data generated by project screening subsystem 310 and generate one or more capital allocation scenarios or options that may be used to allocate capital among potential projects. Capital allocation subsystem 320 may be configured to interact with various peripherals such as a terminal, keyboard, mouse, display screen, printer, stylus, input device, output device, or any other apparatus.

As shown in FIG. 5, capital allocation subsystem 320 may include a communication interface 510, data store 520, memory unit 530, processor 540, input/output unit 545 (“I/O unit 545”), graphics engine 550, output driver 560, and display 570 communicatively connected to one another. While an exemplary capital allocation subsystem 320 is shown in FIG. 5, the exemplary components illustrated in FIG. 5 are not intended to be limiting. Indeed, additional or alternative components and/or implementations may be included within the capital allocation subsystem 320.

Communication interface 510 may be configured to send and receive data to/from project screening subsystem 310. Communication interface 510 may include any device, logic, and/or other technologies suitable for transmitting and receiving project data. The communication interface 510 may be configured to interface with any suitable communication media, protocols, formats, platforms, and networks, including any of those mentioned herein.

Data store 520 may include one or more data storage media, devices, or configurations and may employ any type, form, and combination of storage media. For example, the data store 520 may include, but is not limited to, a hard drive, network drive, flash drive, magnetic disc, optical disc, or other non-volatile storage unit. Data, including project data, capital restraints, capital allocations, etc., may be temporarily and/or permanently stored in data store 520.

Memory unit 530 may include, but is not limited to, FLASH memory, RAM, DRAM, or a combination thereof. In some examples, as will be described in more detail below, applications executed by the capital allocation subsystem 320 may reside in memory unit 530.

Processor 540 may be configured to control operations of components of the capital allocation subsystem 320. Processor 540 may direct execution of operations in accordance with computer-executable instructions such as may be stored in memory unit 530. As an example, processor 540 may be configured to process project data communicated to the capital allocation subsystem 320 from the project screening subsystem 310.

I/O unit 545 may be configured to receive user input and provide user output and may include any hardware, firmware, software, or combination thereof supportive of input and output capabilities. For example, I/O unit 545 may include one or more devices for inputting project data and may include, but is not limited to, a keyboard or keypad, a touch screen component, a mouse or other pointer device, etc.

As instructed by processor 540, graphics engine 550 may generate graphics, which may include tables, reports, charts, graphical spreadsheets, and/or any other graphical user interface (“GUI”). The output driver 560 may provide output signals representative of the graphics generated by graphics engine 550 to display 570. The display 570 may then present the graphics for experiencing by the user.

One or more applications (e.g., 580-1 and 580-2, collectively referred to herein as 580) may be executed by the capital allocation subsystem 320. The applications 580, or application clients, may reside in memory unit 530 or in any other area of the capital allocation subsystem 320 and be executed by the processor 540. Each application 580 may correspond to a particular feature or capability of the capital allocation subsystem 320. For example, illustrative applications 580 may include a capital allocation tool application 580-1 and an allocation analysis application 580-2 configured to analyze project data and generate one or more allocation scenarios. Additional or alternative applications 580 may be included within capital allocation subsystem 320 as may serve a particular application.

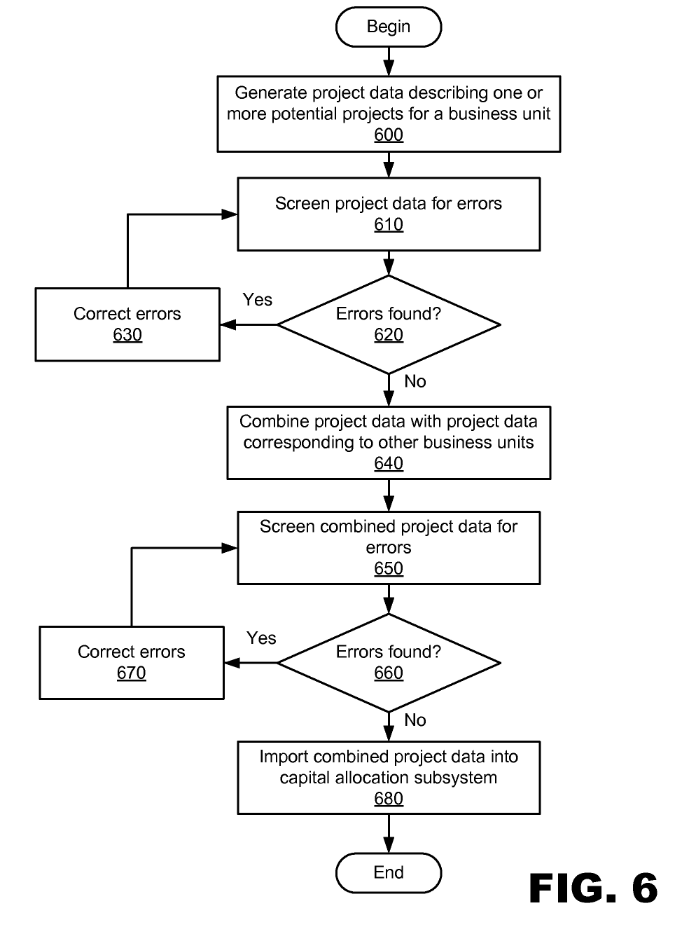

FIG. 6 illustrates an exemplary method of screening or preparing project data for input into capital allocation subsystem 320. While FIG. 6 illustrates exemplary steps according to one implementation, other implementations may omit, add to, reorder, and/or modify any of the steps shown in FIG. 6.

In step 600, project data describing one or more potential projects for a particular business unit 120 is generated. In step 610, the project data for the business unit 120 is screened for errors. A determination is made whether errors are contained within the project data, as shown in step 620. If errors are found within the project data, the errors may be corrected, as shown in step 630.

To facilitate generation of project data for a particular business unit 120 by a user, screening of the project data for errors, and correction of those errors, project screening subsystem 310 may be configured to display a project data input template. In some examples, a distinct project data input template may be presented to each business unit 120 within organization 110. Each business unit 120 may then enter project data corresponding to one or more potential projects into the project data input templates.

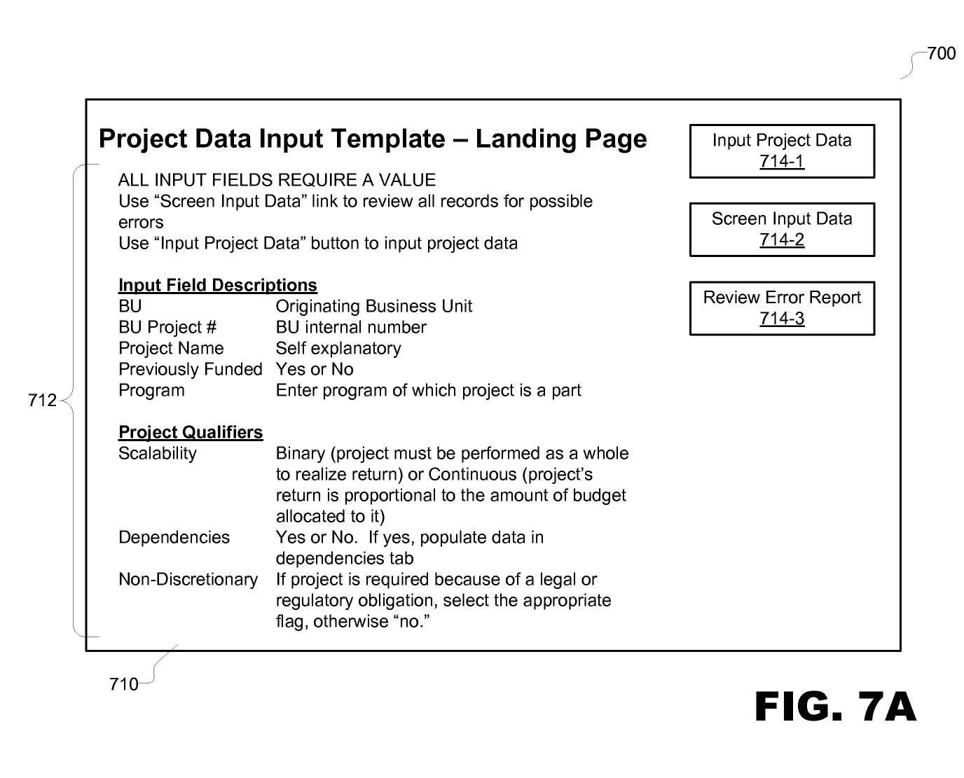

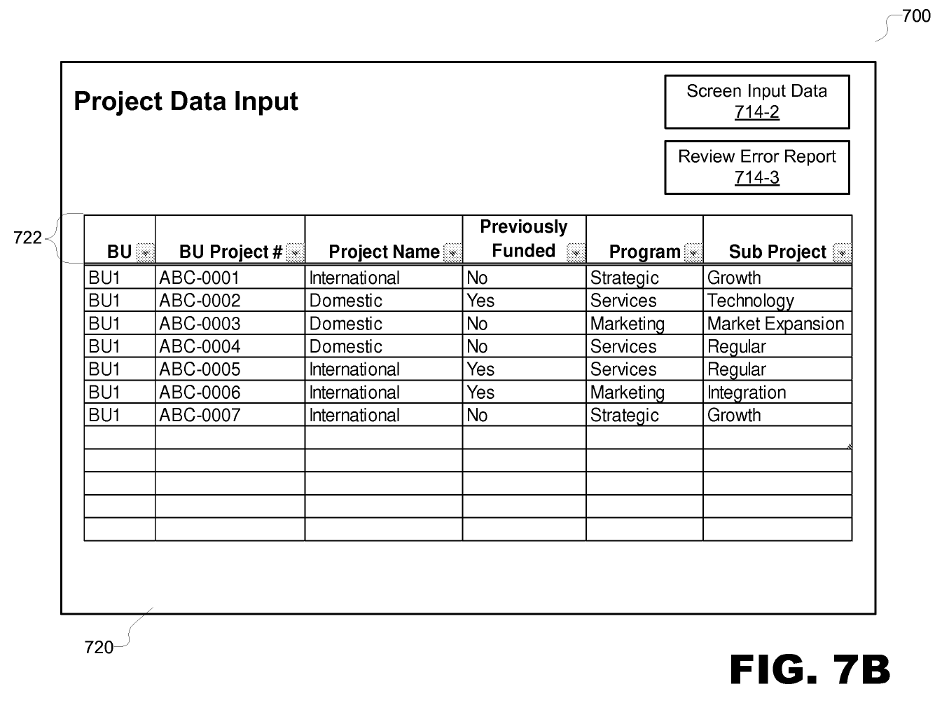

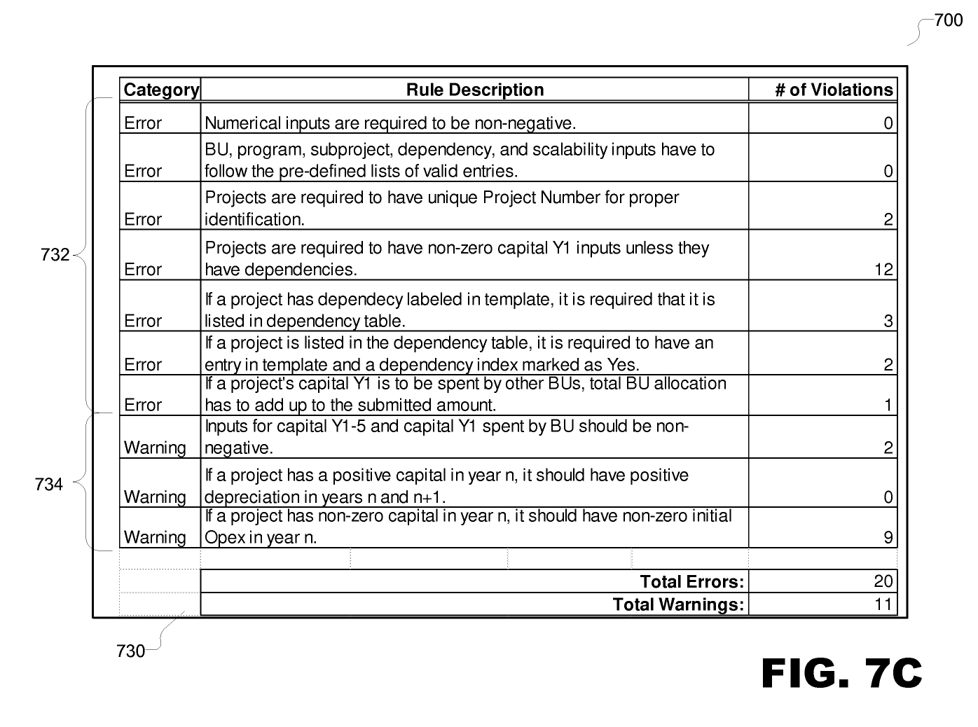

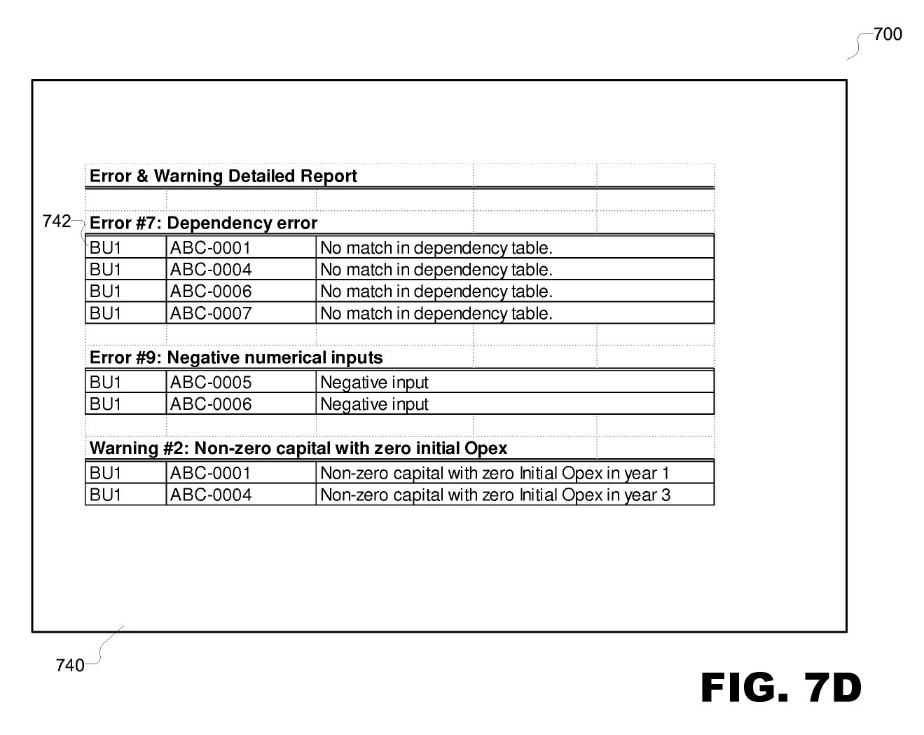

FIGS. 7A-7D illustrate an exemplary project data input template 700 configured to facilitate generation of project data by a user within a particular business unit 120. As used herein, a “template,” such as project data input template 700, may include one or more GUIs. The GUIs may be presented or displayed within Microsoft Excel as one or more worksheets. Alternatively, the GUIs shown and described herein may be presented within a custom software program or within any other suitable software program as may serve a particular application. Moreover, it will be recognized that the GUIs shown and described herein are merely illustrative of the many different types and forms of GUIs that may be used in connection with the systems and methods described herein.

FIG. 7A illustrates an exemplary landing page 710 for a project data input template 700 that may be presented to a user of a particular business unit 120. As shown in FIG. 7A, landing page 710 may be configured to display one or more instructions 712 for generating project data. For example, the instructions 712 may include descriptions of one or more input fields and/or one or more project qualifiers that may be entered to generate project data.

Landing page 710 may additionally or alternatively display one or more selectable links (e.g., 714-1 through 714-3, collectively referred to herein as 714). When selected, each link 714 may cause a different GUI within the input template 700 to be displayed.

For example, FIG. 7B illustrates an exemplary input data GUI 720 that may be displayed when the “input project data” link 714-1 is selected. Input data GUI 720 may be used to input project data corresponding to one or more potential projects for a particular business unit 120 into a database or other data storage medium within project screening subsystem 310. In some examples, input data GUI 720 is customizable and may be configured to display and/or facilitate entry of any type of project data as may serve a particular application.

In some examples, project data may include a number of project qualifiers 722 that are input by the user for each potential project. As shown in FIG. 7B, these project qualifiers 722 may include a name of the business unit 1 20 corresponding to the potential project, a project identification number or code, a name of the potential project, a name of a program of which the potential project is a part, a sub-project of the potential project, and/or various other project qualifiers corresponding to the potential project. The input data may additionally or alternatively include financial data corresponding to each potential project.

In some examples, project data corresponding to any number of potential projects within a particular business 120 may be input by the user. To illustrate, project data for seven potential projects within a business unit named “BU1” is shown in FIG. 7B. Also shown in FIG. 7B are a number of empty rows where the user may input additional project data for other potential projects as desired.

In some examples, project data may also include project dependency information. Project dependency information describes one or more dependent relationships between two or more potential projects. A dependency table, for example, may be provided by project data input template 700 to facilitate entry of project dependency information.

After project data is entered for a desired number of potential projects, a user may select a “screen data” link 714-2 to screen the input project data for errors. When the “screen data” link 714-2 is selected, project screening subsystem 310 analyzes the input project data to determine whether the input project data contains errors, which may include omissions, mistakes, and/or any other type of data entry error. In some examples, project screening subsystem 310 screens project data for errors according to a set of rules defined within Microsoft Excel, Visual Basic, and/or any other programming language or environment.

FIG. 7C shows an exemplary GUI 730 configured to display a summary of errors 732 found within an exemplary set of input project data. GUI 730 may be displayed after “Review Error Report” link 714-3 is selected, for example. As shown in FIG. 7C, a variety of different types of errors may exist within input project data including, but not limited to, erroneous numerical inputs, invalid project dependency information, and invalid financial information. FIG. 7C also shows that GUI 730 may be configured to display a number of violations of each possible error contained within a set of input project data.

As shown in FIG. 7C, project screening subsystem 310 may additionally or alternatively be configured to display a summary of warnings 734 for a particular set of input project data. The warnings may include indications of potentially problematic project data.

FIG. 7D illustrates an exemplary GUI 740 configured to display a detailed errors and warning report that may be generated after the project data is screened for errors. As shown in FIG. 7D, the detailed report may include an explanation of each error and/or warning found within the input project data and listings of potential projects that include those errors and/or warnings. For example, FIG. 7D shows that the input project data for four potential projects within BU1 includes a dependency error and that the input project data for two potential projects within BU1 includes a “negative numerical input” error. FIG. 7D also shows that the input project data for two potential projects within BU1 includes a “non-zero capital with zero initial operating expense” warning. It will be recognized that GUI 740 is customizable and may be configured to display any pertinent information for each error and/or warning as may serve a particular application.

In some examples, a user may double click or otherwise select a potential project listed within GUI 740 to modify the project data corresponding to that project in order to correct the error and/or address the warning. For example, the user may select any of the fields located within the row labeled 742 to modify the project data corresponding to the project labeled ABC-0001. In some examples, the project data may be modified directly within GUI 740. In some alternative examples, project screening subsystem 310 may be configured to redisplay input data GUI 720 or another suitable GUI, where the project data may be modified by the user.

As shown in step 640 of FIG. 6, after the project data has been screened for errors, the project data may be combined with project data corresponding to one or more other business units 120. To this end, project data entered into project data input template 700 for each business unit 120 within organization 110 may be saved as distinct computer-readable data files. For example, project data corresponding to a particular business unit 120 may be saved as a Microsoft Excel file, a text file, an extensible markup language (“XML”) file, or as any other type of data file as may serve a particular application.

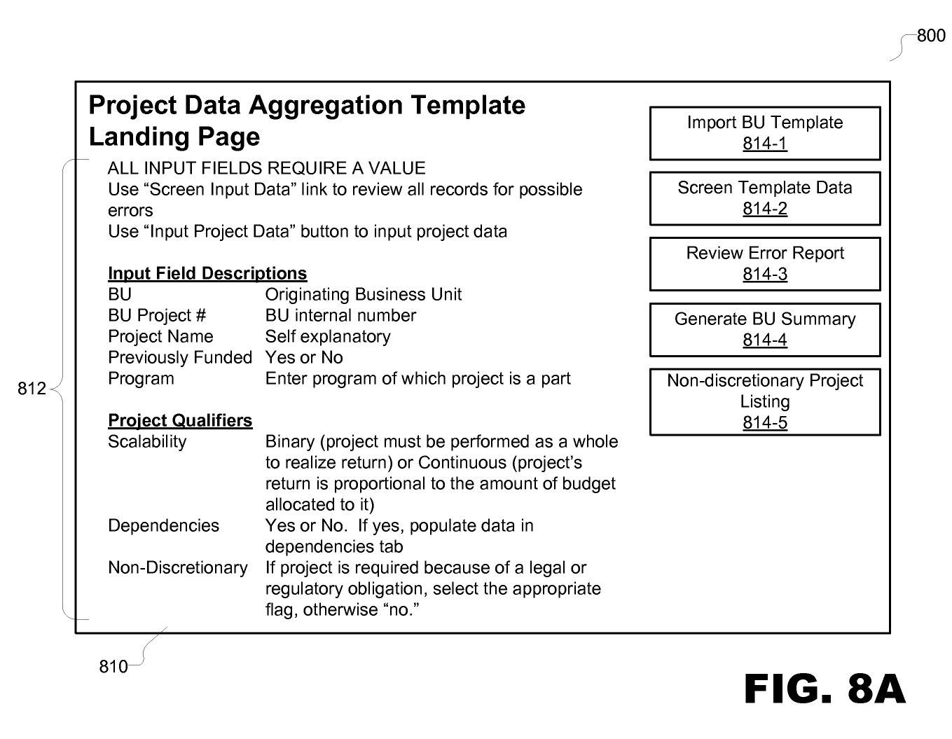

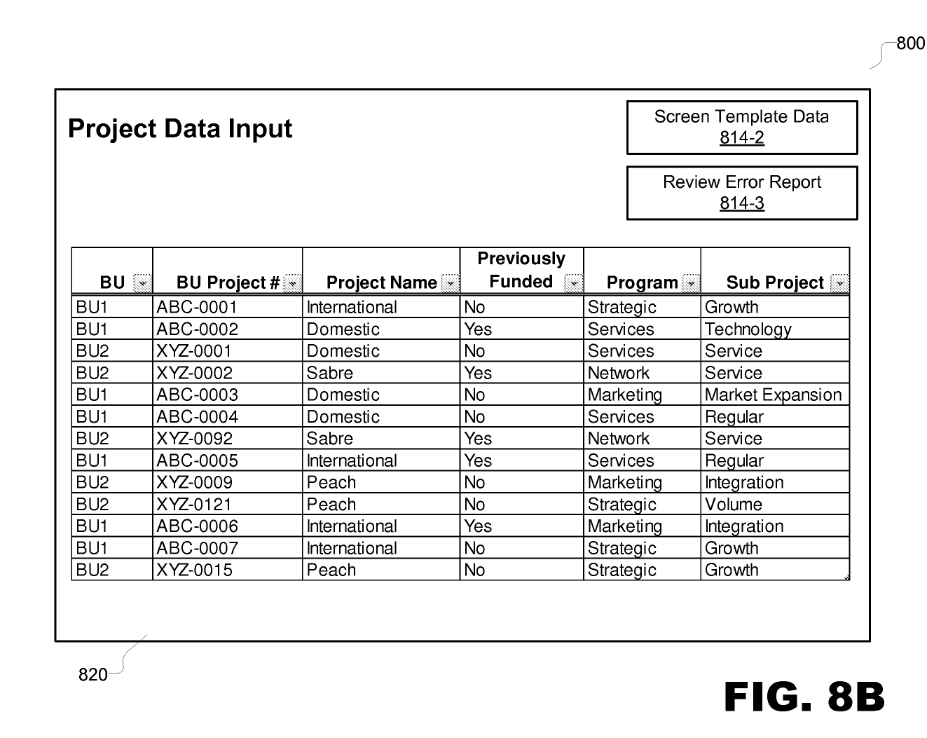

In some examples, project screening subsystem 310 may be configured to automatically combine or aggregate project data corresponding a plurality of business units 120 within organization 110 by extracting project data from the data files created within project data input template 700 by each business unit 120. Additionally or alternatively, as shown in FIGS. 8A-8B, project screening subsystem 310 may be configured to generate and display a project data aggregation template 800. As will be described in more detail below, project data aggregation template 800 may be configured to facilitate aggregation and screening of project data corresponding to a plurality of business units 120. The aggregated project data may then be saved as a single computer-readable data file and transmitted to capital allocation subsystem 320.

FIG. 8A illustrates an exemplary landing page 810 for project data aggregation template 800 that may be presented to a user within organization 110. Landing page 810 may be configured to display one or more instructions 812 for combining or aggregating project data corresponding to multiple business units 120. In some examples, instructions 812 may be similar to those displayed in landing page 710. Instructions 812 may additionally or alternatively include instructions regarding the process of aggregating project data corresponding to multiple business units 120.

Landing page 810 may additionally or alternatively display one or more selectable links (e.g., 814-1 through 814-5, collectively referred to herein as 814). When selected, each link 814 may cause a different GUI within the project data aggregation template 800 to be displayed.

For example, to combine project data for multiple business units 120 within organization 110, the user may select an “input business unit template” link 814-1. The user may then be prompted to enter a path of one or more data files containing project data for one or more corresponding business units 120. Project screening subsystem 310 may then extract project data from the selected data files and combine the extracted data. Alternatively, project screening subsystem 310 may be configured to open individual project data input templates 700 for each of the selected business units 120. A user may then manually combine the project data by copying and pasting project data from each of the open project data input templates 700.

FIG. 8B illustrates an exemplary GUI 820 showing combined project data corresponding to two distinct business units 120, B1 and B2. While project data corresponding to two distinct business units 120 is shown in FIG. 8B, it will be recognized that GUI 820 may be configured to display project data corresponding to any number of business units 120 as may serve a particular application. It will also be recognized that GUI 820 may be customizable and configured to display and/or facilitate entry of any type of project data as may serve a particular application. Moreover, the project data shown in GUI 820 may be sorted in any manner as may serve a particular application.

In step 650 of FIG. 6, the combined project data is screened for errors. A determination is made whether errors are contained within the combined project data, as shown in step 660. If errors are found within the combined project data, the errors may be corrected, as shown in step 670.

In some examples, a user may select a link within landing page 810 and/or GUI 820, such as the “screen template data” link 814-2, to screen the combined project data for errors. The user may also select a link, such as the “review error report” link 814-3, to generate GUIs similar to GUIs 730 and 740 shown in FIGS. 7C and 7D, respectively.

Additional or alternative links may be displayed within landing page 810. For example, a “generate BU summary” link 814-4 may be displayed within landing page 810 and configured to generate a summary of potential projects for a particular business unit 120. A “non-discretionary project listing” link 814-5 may also be displayed and configured to display a list of non-discretionary projects that have to be funded.

After project data corresponding to potential projects within multiple business units 120 is combined and screened for errors, the combined project data may be imported into capital allocation subsystem 320, as shown in step 680 of FIG. 6. As will be described in more detail below, capital allocation subsystem 320 may be configured to analyze the combined project data and generate one or more capital allocation scenarios that may be used to allocate capital among the potential projects represented by the combined project data.

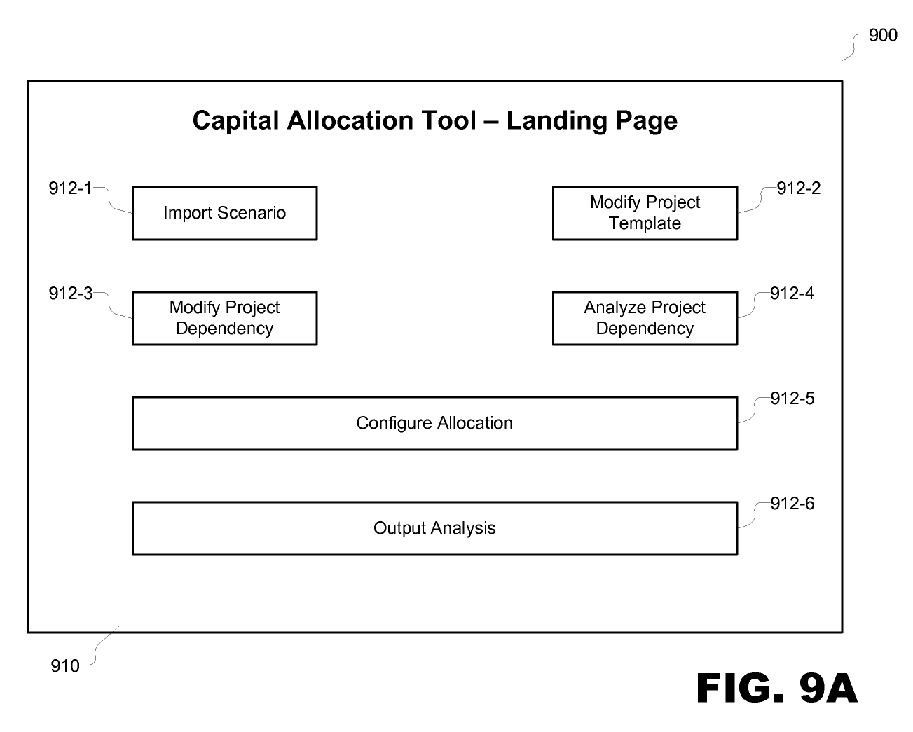

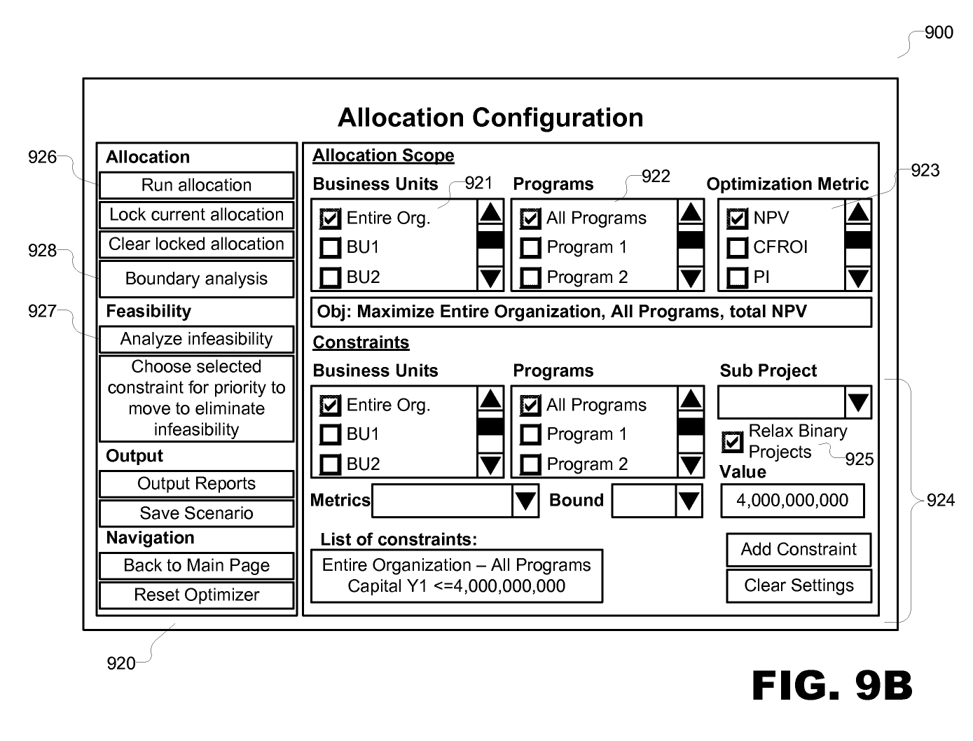

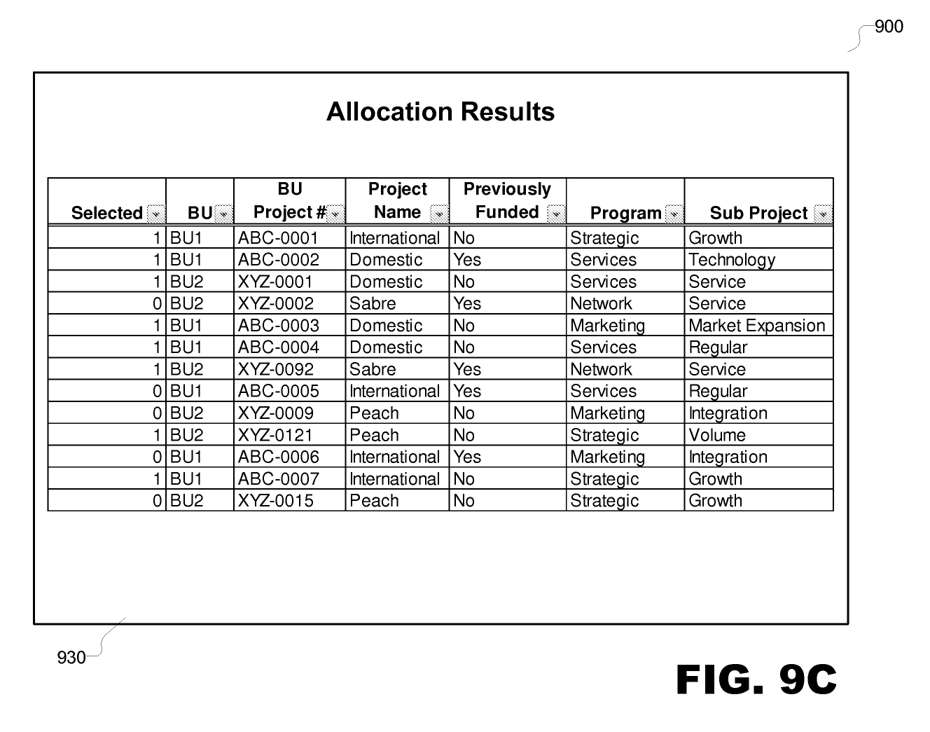

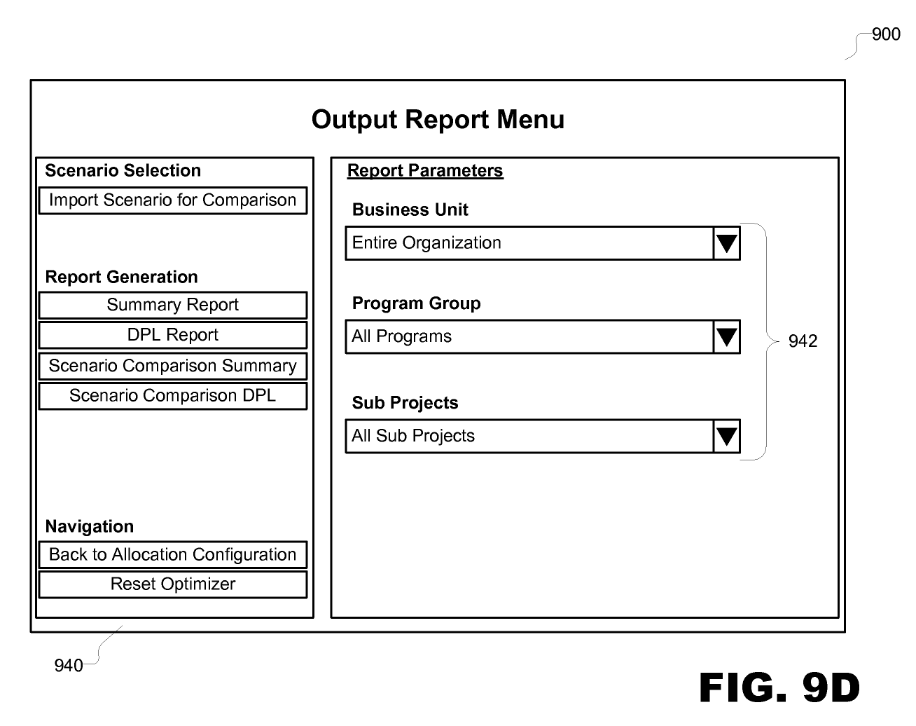

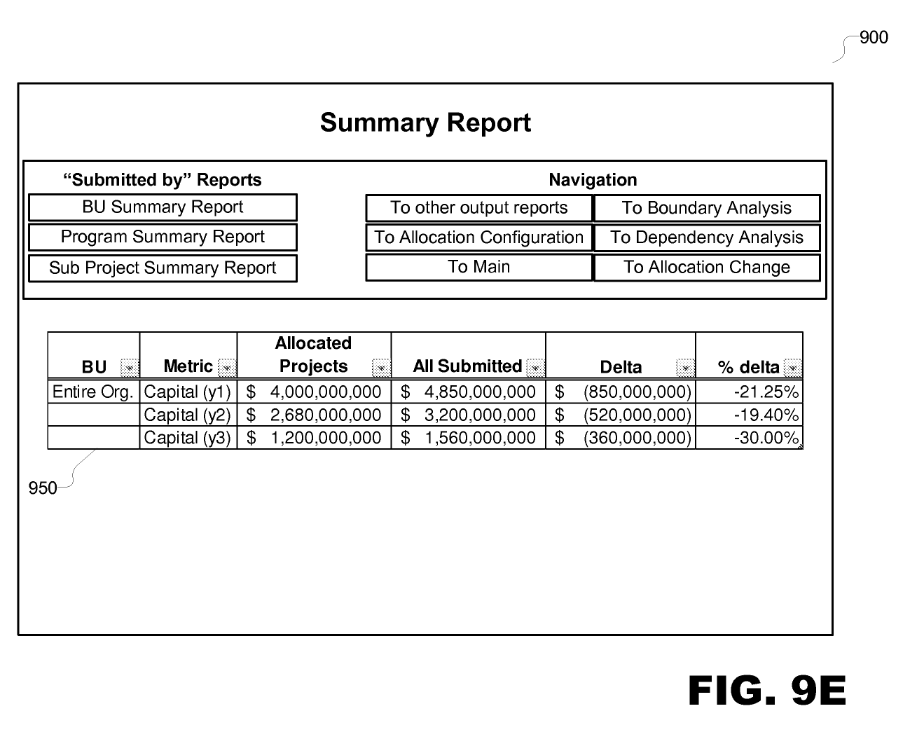

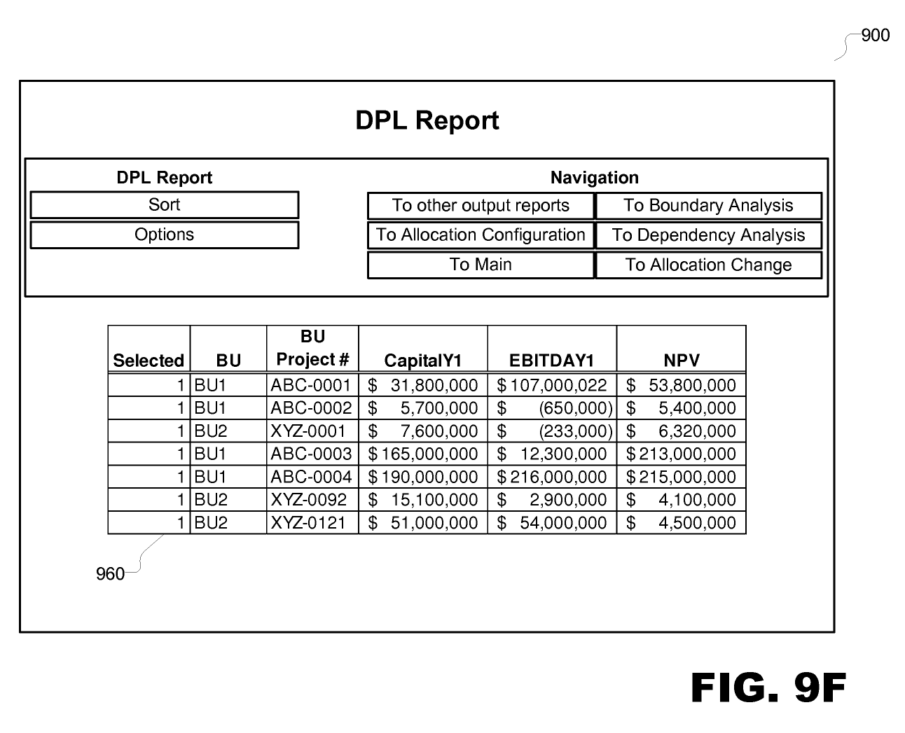

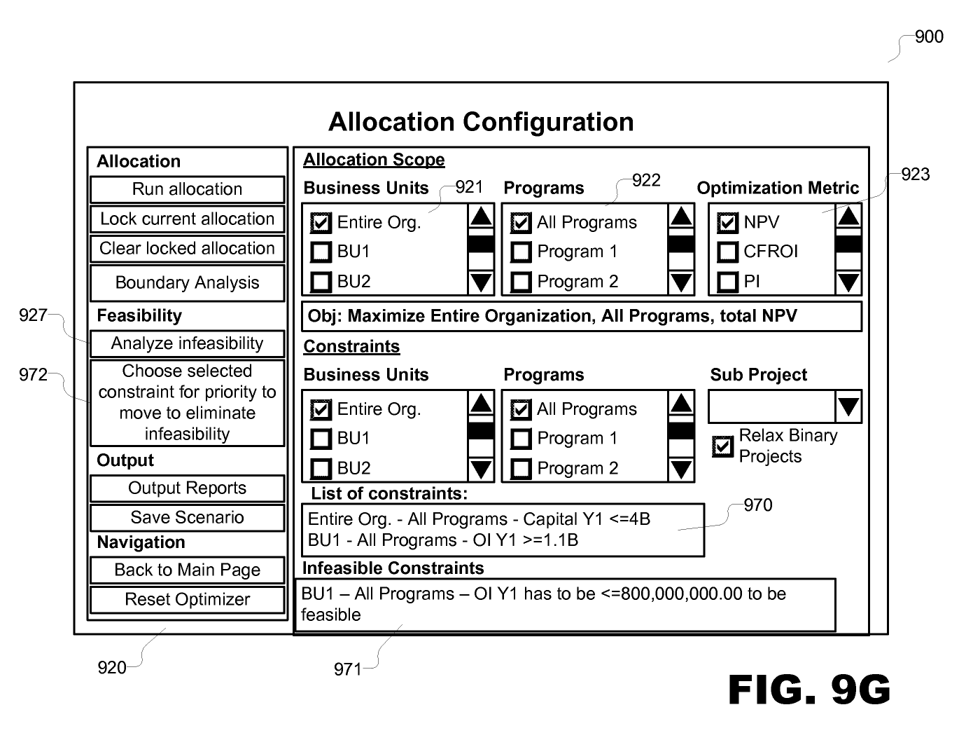

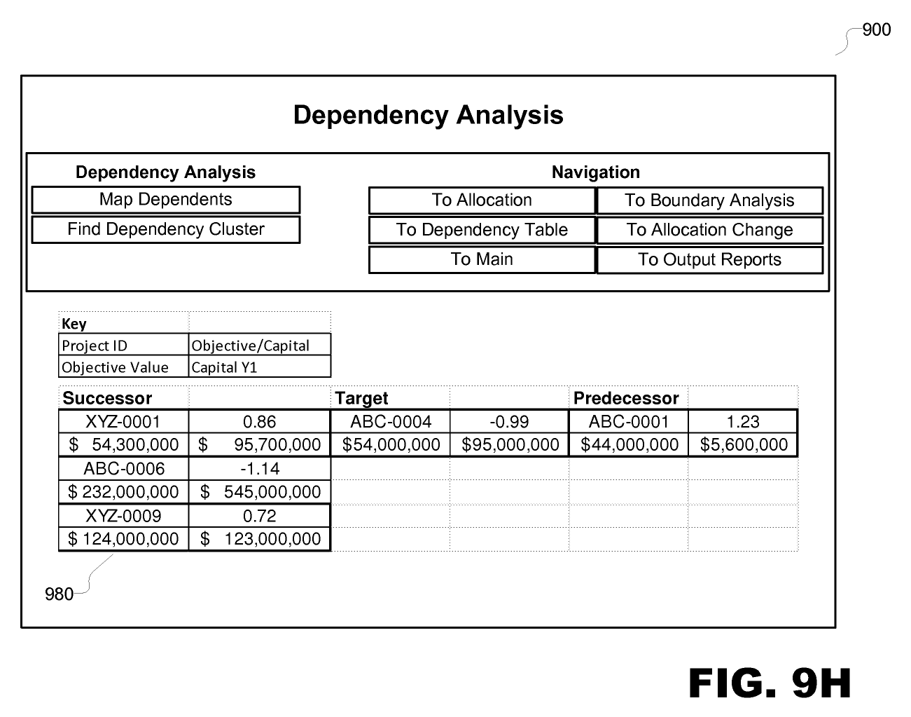

In some examples, capital allocation subsystem 320 may be configured to execute a capital allocation tool configured to facilitate generation of one or more capital allocation scenarios. FIGS. 9A-9H Illustrate various GUIs within an exemplary capital allocation tool 900 that may be displayed by capital allocation subsystem 320. It will be recognized that the GUIs shown and described in connection with the exemplary capital allocation tool 900 are merely illustrative and that they may be modified as may serve a particular application. Moreover, it will be recognized that one or more GUIs and/or functions of the capital allocation tool 900 may be realized in Microsoft Excel, Visual Basic, Frontline Solver, and/or any other optimization engine or software as may serve a particular application.

FIG. 9A illustrates an exemplary landing page 910 for the capital allocation tool 900. As shown in FIG. 9A, landing page 910 may include one or more links (e.g., 912-1 through 912-6, collectively referred to herein as 912). Each link 912 may be configured to perform one or more operations and/or display one or more GUIs when selected by a user. While links 912-1 through 912-6 are shown in FIG. 9A, it will be recognized that additional or alternative links may be displayed within landing page 910 as may serve a particular application.

In some examples, “import scenario” link 912-1 may be selected to import one or more saved allocation scenarios. Additionally or alternatively, import scenario link 912-1 may be selected to import a new set of combined project data as saved by data screening subsystem 310.

After a set of combined project data has been imported into capital allocation tool 900, a user may initiate analysis and/or modification of the imported project data by selecting one or more of links 912-2 through 912-4. Link 912-2, labeled “modify project template,” may be selected to modify one or more project qualifiers within the project data, link 912-3, labeled “modify project dependency,” may be selected to modify one or more project dependencies within the project data, and link 912-4, labeled “analyze project dependency,” may be selected to analyze one or more project dependencies within the project data.

Link 912-5, labeled “configure allocation,” may be selected to display an allocation configuration GUI wherein the user may configure a number of parameters that govern how a capital allocation scenario is generated. FIG. 9B illustrates an exemplary allocation configuration GUI 920 that may be displayed when link 912-5 is selected. As will be described in more detail below, allocation configuration GUI 920 may be used to determine an allocation objective, determine an allocation constraint set, and perform allocation optimizations.

As used herein, “allocation objective” defines a scope within which the capital allocation subsystem 320 generates an allocation scenario. For example, interactive field 921 within allocation configuration GUI 920 allows a user to select an entire organization or one or more business units 120 to be included within a particular allocation scenario. Interactive field 922 allows a user to select one or more programs to be included within a particular allocation scenario. Interactive field 923 allows a user to select an optimization metric to be used within the allocation scenario. Exemplary optimization metrics include, but are not limited to, NPV, CFROI, PI, EBITDA, OI, and revenue.

Allocation configuration GUI 920 may additionally or alternatively be configured to facilitate determination of an allocation constraint set used for a particular allocation scenario. To this end, allocation configuration GUI 920 may include Interactive fields 924 configured to facilitate entry of one or more constraints that are used within a particular allocation scenario. Exemplary constraints that may be input by the user include, but are not limited to, upper and lower capital expenditure bounds, business unit constraints, program constraints, and sub-project constraints. For example, FIG. 9B shows that a constraint of 4 billion dollars capital expenditure during year one (“Y1”) across the entire organization and across all programs has been entered. However, it will be recognized that the allocation constraint set shown in FIG. 9B is merely illustrative and that any other constraint set may be selected as may serve a particular allocation scenario.

In some examples, allocation configuration GUI 920 may include an interactive field 925 configured to allow a user to select an option to relax binary projects. As used herein, a “binary” project is a project that must be performed as a whole to realize a return. If the user chooses to relax binary projects by selecting interactive field 925, capital allocation subsystem 320 treats binary projects as continuous projects. As used herein, a “continuous” project is a project having a return proportional to the amount of capital allocated to it.

After the allocation objective and allocation constraint set have been determined, a user may select link 926, labeled “run allocation,” to cause capital allocation subsystem 320 to generate an allocation scenario in accordance with the allocation objective and constraint set. In some examples, capital allocation subsystem 320 may generate the allocation scenario in accordance with one or more formulas programmed into Microsoft Excel, Visual Basic, or any other suitable software program.

In some examples, the results of the generated allocation scenario are automatically saved for future use. Additionally or alternatively, as shown in FIG. 9C, the results of the generated allocation scenario may be displayed within a results page 930. As shown in FIG. 9C, a list of each potential project may be displayed by capital allocation subsystem 320 along with an indication of whether each potential project has been selected for capital allocation. For ease of explanation, the term “allocated project” will be used to refer to a potential project that is selected for capital allocation. Likewise, the term “non-allocated project” will be used to refer to a potential project that is not selected for capital allocation.

To illustrate, a “1” or a “0” may be displayed next to each potential project to indicate whether that project is an allocated project. A “1” indicates that a project is an allocated project and a “0” indicates that a project is a non-allocated project. In some examples, a number between 0 and 1 may alternatively be displayed next to a particular project to indicate that that project has been partially selected for capital allocation.

After an allocation scenario is generated, capital allocation subsystem 320 may generate and display one or more customizable reports to facilitate analysis of the allocation scenario. To this end, as shown in FIG. 9D, an output report menu GUI 940 may be generated and displayed by capital allocation subsystem 320.

Output report menu GUI 940 may be configured to facilitate generation of one or more customizable reports related to one or more allocation scenarios. For example, a user may select a summary report, a detailed project listing (“DPL”) report, a scenario comparison summary report, a scenario comparison DPL report, and/or any other report as may serve a particular application. Various report parameters 942 may be entered by the user, such as, but not limited to, which business unit(s) 120, program group(s), and sub-project(s) to include within a particular report that is generated.

FIG. 9E illustrates an exemplary summary report 950 that may be generated and displayed by capital allocation subsystem 320. As shown in FIG. 9E, summary report 950 displays a comparison of allocated capital for three different years (y1 through y3) to a total value for all submitted projects within an entire organization 110. While the particular summary report 950 of FIG. 9E corresponds to an entire organization 110, it will be recognized that similar summary reports may be generated and displayed for groups of one or more business units 120 within organization 110. Moreover, it will be recognized that additional or alternative metrics may be used within other summary reports. These metrics may include, but are not limited to, NPV, CFROI, PI, EBITDA, OI, and revenue.

FIG. 9F illustrates an exemplary DPL report 960 that may be generated and displayed by capital allocation subsystem 320. As shown in FIG. 9F, DPL report 960 displays a detailed listing of various metrics for one or more allocated projects. For example, DPL report 960 displays capital, EBITDA, and NPV metrics for each of a number of allocated projects. It will be recognized that DPL report 960 may display any number of metrics for any number of projects as may serve a particular application.

While exemplary project reports are shown in FIGS. 9E and 9F, it will be recognized that these reports are merely illustrative of the many different types of reports that may be generated and displayed by capital allocation subsystem 320. Indeed, any other customized report may be generated and displayed as may serve a particular application.

Capital allocation tool 900 may additionally or alternatively include one or more allocation analysis tools. For example, capital allocation tool 900 may include an infeasibility analysis tool, which may be accessed by selecting an “analyze infeasibility” link 927 within allocation configuration GUI 920. Infeasibility analysis tool may be configured to generate and display one or more infeasible constraints in a particular allocation scenario.

To illustrate the functionality of the infeasibility analysis tool, FIG. 9G shows the exemplary allocation configuration GUI 920 of FIG. 9B wherein two constraints have been input by a user, as shown in interactive field 970. As shown in FIG. 9G, the two constraints include a first constraint of 4 billion dollars capital expenditure during Y1 across the entire organization and across all programs and a second constraint of 1.1 billion dollars OI for business unit BU1.

After an allocation scenario has been generated based on these constraints, capital allocation subsystem 320 may determine that the combination of these constraints is infeasible. A user may then select the “analyze infeasibility” link 927 to determine the amount that one or more of the constraints needs to be adjusted in order to result in a feasible solution. To illustrate, field 971 in FIG. 9G shows that the OI constraint for BU1 has to be less than or equal to approximately 800 million dollars to make the combination of constraints feasible. Capital allocation subsystem 320 may use any suitable heuristic or formula in determining feasibility of a particular set of constraints.

In some examples, a user may choose a particular constraint to move to eliminate infeasibility by selecting link 972. For example, if there are multiple constraints, the user may select one of those constraints as the constraint that is adjusted to eliminate infeasibility.

Capital allocation tool 900 may additionally or alternatively include a dependency mapping tool. As mentioned, in a relatively large organization 110, there may exist many projects that are interrelated or otherwise dependent on one another. It is often desirable for a user to be able to quickly view a group of interdependent projects.

To this end, in some examples, a user may right-click or otherwise select a project identification number that is displayed within any one of the GUIs described herein and select an option to analyze the dependencies of the corresponding project. FIG. 9H illustrates an exemplary dependency analysis GUI 980 for a particular project. As shown in FIG. 9H, the dependency analysis GUI 980 may be configured to display any successor projects to the selected project and any predecessor projects to the selected project. It will be recognized that any number of levels of dependencies may be displayed by dependency analysis GUI 980 as may serve a particular application.

Dependency analysis GUI 980 may be configured to explain allocation output results dictated by dependencies. For example, a user may desire to know why a particular project was selected for capital allocation, even though that particular project does not have an appropriate objective financial value. By analyzing the dependent projects to that project, it may be discovered that one or more of the dependent projects has a high potential value.

Dependency analysis GUI 980 may also be configured to indicate whether projects listed therein are allocated projects or non-allocated projects. In some examples, different colors may be used to distinguish allocated projects from non-allocated projects. Additionally or alternatively, dependency analysis GUI 980 may be configured to indicate whether projects listed therein are “forced in” or “forced out.” A “forced in” project has to be selected for capital allocation, regardless of any constraints or objectives indicated by user. Likewise, a “forced out” project cannot be selected for capital allocation. Forced in and forced out projects may be indicated within project data input template 700 or within any other GUI generated by project screening subsystem 310 or capital allocation subsystem 320 as may serve a particular application.

As mentioned, typical capital allocation techniques include formulating an optimization problem with an objective function to maximize (e.g., NPV, CFROI, etc.), with constraints on capital expenditures and other financial metrics, and constraints that enforce project dependencies. However, these techniques are not well suited for determining budget levels because the marginal return may not be as high as it could be with slightly different constraint values.

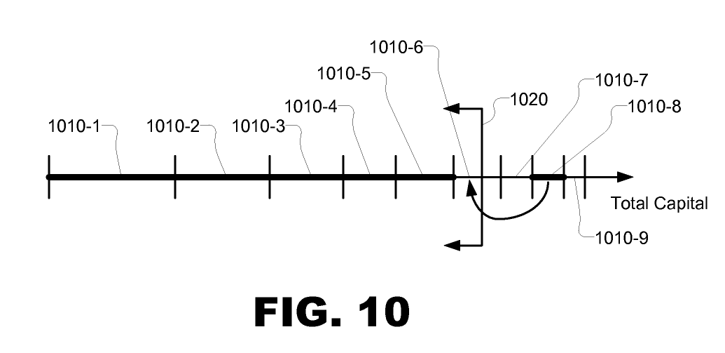

To illustrate, FIG. 10 is a diagram illustrating an exemplary process used to allocate capital among a number of potential binary projects (e.g., 1010-1 through 1010-9, collectively referred to herein as 1010) within an organization 110 for the simple case of a single budget constraint and no project dependencies. As shown in FIG. 10, the potential binary projects 1010 are separated one from another by vertical lines for illustrative purposes and are listed in descending index order. In other words, the potential binary projects 1010 are listed in order of descending return on capital. As used herein, “return on capital” refers to value received from capital allocation as measured using any suitable metric (e.g., NPV). As shown in FIG. 10, potential project 1010-1 has the highest return on capital and project 1010-9 has the lowest return on capital. It will be assumed for illustrative purposes that none of the projects 1010 have any dependencies.

An exemplary budget constraint is represented by line 1020. In general, organization 110 may select a project 1010 for capital allocation as long as there is available capital within constraint 1020. Hence, in the example of FIG. 10, organization 110 may select projects 1010-1 through 1010-5 for capital allocation because those projects are located completely to the left of line 1020. Selected projects 1010 are indicated in FIG. 10 by a bolded line.

As shown in FIG. 10, the “next best” project, in terms of return on capital, is project 1010-6. However, if project 1010-6 is completely funded, total capital allocation will exceed constraint 1020. Hence, project 1010-6 may be referred to as being “on the margin” of constraint 1020 because it does not entirely fit within constraint 1020. As used herein, the term “marginal project” refers to a project that does not entirely fit within a particular constraint (e.g., constraint 1020). There may be multiple marginal projects and/or clusters of marginal projects in an organization with multiple constraints and/or project dependencies.

In some capital allocation techniques, marginal projects, such as project 1010-6, are not selected for capital allocation because they do not fit entirely within a particular constraint (e.g., constraint 1020). Instead, these capital allocation techniques may select a project having a lower return on capital as long as the total capital allocation remains within the constraint.

To illustrate, some capital allocation techniques may select project 1010-8 to remain within constraint 1020. By so doing, marginal projects 1010-6 and 1010-7 are refused for capital allocation, even though those projects have a higher return on capital than project 1010-8.

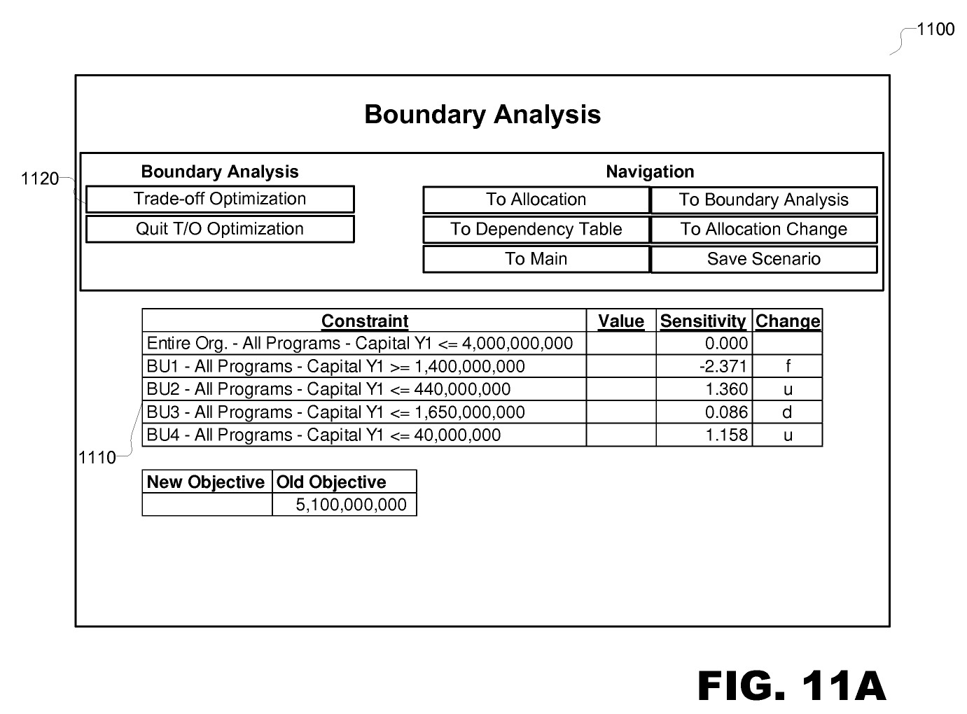

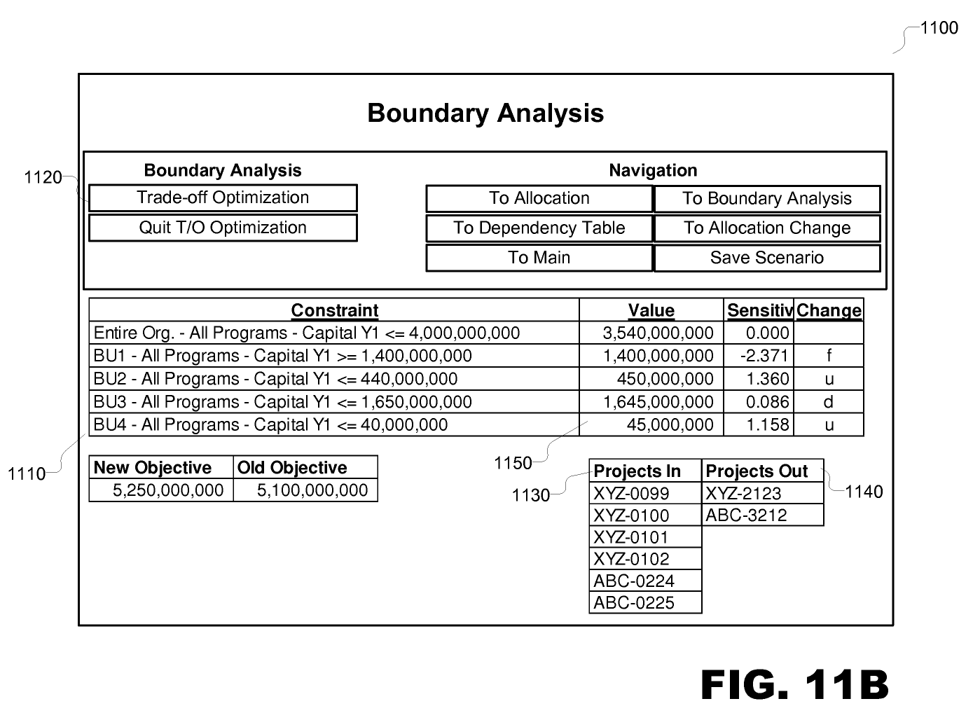

However, many organizations are more interested in determining capital constraints that optimize or maximize returns on capital than allocating capital to sub-optimal projects merely to use up available capital within a rigid budget constraint. To this end, capital allocation subsystem 320 may additionally or alternatively include a boundary analysis tool configured to determine one or more capital constraints that optimize or maximize one or more returns on capital. FIGS. 11A-11B illustrate exemplary GUIs that may be displayed within a boundary analysis tool 1100. Boundary analysis tool 1100 may be displayed after user selects “boundary analysis” link 928 within allocation configuration GUI 920. As will be described in more detail below, boundary analysis tool 1100 may be configured to determine marginal allocations in the vicinity of flexible constraints.

In some examples, boundary analysis tool 1100 first identifies one or more marginal projects within a set of potential projects. As mentioned, there may be multiple marginal projects and/or clusters of marginal projects in an organization with multiple constraints and/or project dependencies. Boundary analysis tool 1100 may be configured to identify marginal projects using any suitable processing or optimization engine as may serve a particular application.

Boundary analysis tool 1100 may then determine a cutoff return on capital implied by one or more constraints if all potential projects are assumed to be continuous. In a one-dimensional example with one constraint and no project dependencies, this cutoff return on capital may be represented by the variable “r.”

The boundary analysis tool 1100 may then remove the constraints and find one or more optimal allocation solutions among the potential projects without the constraints and in accordance with the determined cutoff return on capital.

In the one-dimensional example with one constraint and no project dependencies, the optimal allocation may be calculated by maximizing the equation NPV_{org}−r*capital(Y1)_{marginal}, wherein NPV_{org} represents the NPV of the organization and capital(Y1)_{marginal} represents the amount of capital allocated during Y1 to a marginal project selected for capital allocation. Hence, r*capital(Y1)_{marginal} is equal to the NPV of the selected marginal project. It will be recognized that any other metric and/or any other desired year may be used in the above-mentioned equation as may serve a particular application.

It will be recognized that in cases where there exist multiple marginal projects, there may be more than one optimal allocation each including a distinct set of marginal projects. In the equation given above in connection with the one dimensional example, the r*capital(Y1)_{marginal} term effectively cancels out the added NPV that results when a marginal project is selected for capital allocation. Hence, as will be described in more detail below, the boundary analysis tool 1100 may include a trade-off optimization tool configured to generate different allocation scenarios wherein distinct sets of marginal projects are selected for capital allocation. In this manner, a user may analyze various allocation scenarios and choose one that is most desirable.

As shown in FIG. 11A, boundary analysis tool 1100 may calculate and display a “sensitivity” for each constraint included within a set of constraints. This calculation may be performed in accordance with the boundary analysis process as described above. As used herein, the “sensitivity” of a constraint refers to an amount of objective gain/loss for an incremental relaxation of the constraint. For example, the sensitivity of a constraint may refer to the change in return on capital for every additional dollar that is added to the constraint.

For example, table 1110 within boundary analysis tool 1100 shows that five constraints have been input by a user. The first constraint is a budget constraint of 4 billion dollars for the entire organization 110. In this example, the sensitivity for the first constraint is 0.000. In other words, if the first constraint is increased by a dollar, the return on capital (e.g., NPV) of projects within the entire organization 110 that are selected for capital allocation does not change.

As shown in FIG. 11A, the second constraint is that a minimum of 440 million dollars be allocated to projects within business unit BU1. The sensitivity of the second constraint is negative 2.371 because the second constraint is forcing BU1 to spend money on losing projects. In other words, if the second constraint is increased by a dollar, the overall return on capital for projects within BU1 that are selected for capital allocation will decrease by 2.371 dollars.

The third constraint shown in FIG. 11A is a budget constraint of 1.76 billion dollars for projects within business unit BU2. The sensitivity of the third constraint is 1.360. In other words, if the third constraint is increased by a dollar, the overall return on capital for projects within BU2 that are selected for capital allocation will increase by 1.360 dollars. The fourth and fifth constraints are shown in FIG. 11A along with their corresponding sensitivities.

In some examples, a “trade-off optimization” link 1120 may be selected to cause boundary analysis tool 1100 to determine allocation scenarios in which distinct sets of marginal projects are selected for capital allocation. To this end, the trade-off optimization may be configured to optimize or adjust the constraints in accordance with the sensitivities shown in FIG. 11A.

In some examples, the user may force the constraint optimization direction for one or more constraints. For example, a user may desire to optimize the constraint set shown in FIG. 11A by allowing the trade-off optimization to only adjust one or two of the constraints.

To this end, a user may enter a “d” next to the sensitivity level of a desired constraint to allow allocation below the constraint (down), a “u” to allow allocation above the constraint (up), or an “f” to keep the constraint fixed or active. The trade-off optimization procedure may then adjust the constraints in accordance with the forced directions as indicated by the user.

To illustrate, BU2 and BU4 each have relatively high sensitivities. Hence, a user may enter a “u” for their respective constraints, as shown in FIG. 11A. BU3 has a relatively low sensitivity, so the user may enter a “d” for the constraint governing BU3. Finally, because BU1 has a negative sensitivity, the user may enter a “f” to fix the constraint governing BU1.

FIG. 11B shows the boundary analysis tool 1100 after the trade-off optimization has been executed. As shown in FIG. 11B, a list of marginal projects 1130 that were selected for capital allocation as a result of the trade-off optimization may be displayed, as well as a list of marginal projects 1140 that were deselected for capital allocation as a result of the trade-off optimization. New values 1150 for the constraints may also be displayed. These new values 1150 represent a new constraint set configured to allow marginal projects 1130 to be selected for capital allocation.

Boundary analysis and tradeoff optimization may be executed multiple times to generate different allocation scenarios. These scenarios may then be compared one to another. To this end, capital allocation subsystem 320 may additionally or alternatively include a comparative analysis tool configured to compare different allocation scenarios. For example, comparative analysis tool may be configured to show projects that change from one allocation scenario to the next as the constraints are adjusted. Additionally or alternatively, comparative analysis tool may be configured to display one or more reports similar to the reports described hereinabove.

It will also be recognized that the boundary analysis and tradeoff optimization procedures described herein may be performed within Microsoft Excel, Visual Basic, an optimization engine, or any other suitable combination of hardware and software as may serve a particular application.

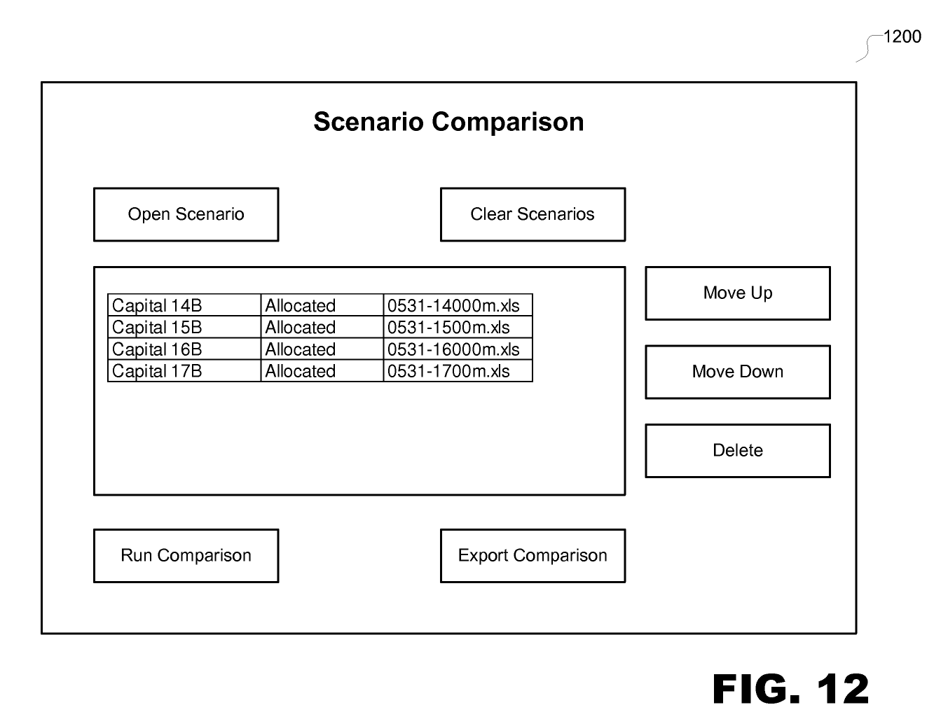

After a particular allocation scenario has been generated, the user may save the scenario for later access and/or comparison with other saved scenarios. FIG. 12 illustrates an exemplary allocation scenario comparison GUI 1200 configured to facilitate comparison of two or more allocation scenarios. As shown in FIG. 12, allocation scenario comparison GUI 1200 may be configured to display the names of a number of data files containing saved allocation scenarios. A user may select two or more of these scenarios to generate one or more comparison reports.

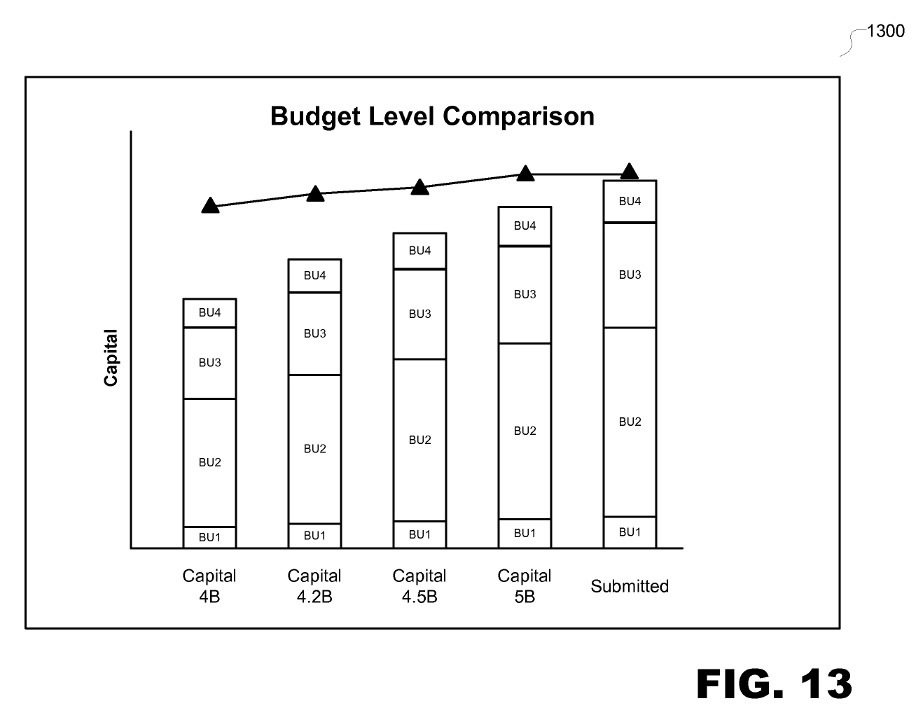

FIG. 13 illustrates an exemplary comparison report 1300 that may be generated to compare two or more allocation scenarios. It will be recognized that additional or alternative reports may be generated and displayed to compare two or more allocation scenarios as may serve a particular application.

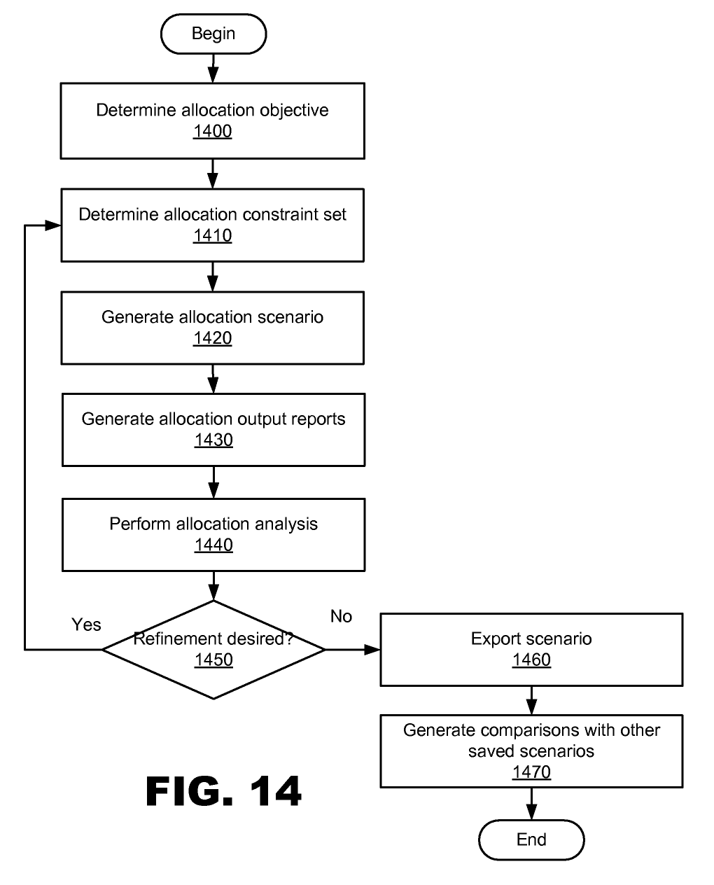

FIG. 14 illustrates an exemplary method of allocating capital among potential projects within various business units 120 of organization 110 based on project data provided by project screening subsystem 310. While FIG. 14 illustrates exemplary steps according to one implementation, other implementations may omit, add to, reorder, and/or modify any of the steps shown in FIG. 14.

In step 1400, a capital allocation objective, or simply “allocation objective” is determined. Allocation objective may be determined in any of the ways described herein.

In step 1410, an allocation constraint set is determined. Allocation constraint set may be determined in any of the ways described herein.

In step 1420, an allocation scenario is generated. The allocation scenario may be generated in any of the ways described herein.

In step 1430, one or more allocation output reports may be generated. The reports may be generated in any of the ways described herein.

In step 1440, allocation analysis may be performed. Allocation analysis may be performed by any of the allocation analysis tools described herein. For example, an infeasibility analysis, a dependency analysis, a boundary analysis, and a trade-off optimization may be performed in any of the ways described herein.

In step 1450, a determination is made if refinement to any of the constraints is desired. If refinements are desired, the allocation constraint set may be determined again and the process repeated. If refinements are not desired, the allocation scenario may be saved or exported, as shown in step 1460.

In step 1470, the exported allocation scenario may be compared to other saved allocation scenarios. To this end, one or more reports may be generated to facilitate analysis of one or more allocation scenarios.

In the preceding description, various exemplary implementations have been described with reference to the accompanying drawings. It will, however, be evident that various modifications and changes may be made thereto, and additional implementations may be implemented, without departing from the scope of the invention as set forth in the claims that follow. For example, certain features of one implementation described herein may be combined with or substituted for features of another implementation described herein. The description and drawings are accordingly to be regarded in an illustrative rather than a restrictive sense.

What is claimed is:

1. A system comprising:
a project screening subsystem; and
a capital allocation subsystem selectively and communicatively coupled to said project screening subsystem;
wherein said project screening subsystem is configured to aggregate project data corresponding to a plurality of potential projects within an organization and communicate said project data to said capital allocation subsystem; and
wherein said capital allocation subsystem is configured to
facilitate input of one or more constraints on allocation of capital among said potential projects; and
adjust at least one of said constraints to select a subset of said potential projects for said allocation of said capital such that a return on said capital is optimized.

2. The system of claim 1, wherein said capital allocation subsystem is further configured to use said constraints to determine one or more marginal projects within said potential projects.

3. The system of claim 2, wherein said capital allocation subsystem is further configured to include at least one of said marginal projects within said subset of said potential projects selected for said allocation of said capital.

4. The system of claim 2, wherein said capital allocation subsystem is configured to generate a sensitivity value for each of said constraints based on said identification of said marginal projects, and wherein said adjustment of said at least one of said constraints is performed in accordance with at least one of said sensitivity values.

5. The system of claim 1, wherein said capital allocation subsystem is further configured to select another distinct subset of said potential projects for said allocation of said capital such that said return on said capital is optimized.

6. The system of claim 5, wherein said capital allocation subsystem is configured to generate one or more reports configured to facilitate comparison of said subsets of said potential projects selected for said allocation of said capital.

7. The system of claim 1, wherein said capital allocation subsystem is configured to generate one or more graphical user interfaces configured to facilitate said input of said one or more constraints and said adjustment of said at least one of said constraints.

8. The system of claim 1, wherein said capital allocation subsystem is configured to perform an infeasibility analysis of one or more of said constraints.

9. The system of claim 1, wherein said capital allocation subsystem is configured to analyze a dependency relationship between two or more of said potential projects.

10. The system of claim 1, wherein said return on said capital is measured based on at least one of net present value, cash flow return on investment, profitability index, revenue, operating income, and earnings before interest, taxes, depreciation, and amortization.

11. The system of claim 1, wherein said one or more constraints comprises at least one capital constraint.

12. The system of claim 1, wherein said organization comprises a plurality of business units each corresponding to at least one of said potential projects.

13. The system of claim 1, wherein two or more of said potential projects are dependent on one another.

14. A method comprising:
analyzing project data corresponding to a plurality of potential projects within an organization;
facilitating input of one or more constraints on allocation of capital among said potential projects;
using said constraints to determine at least one marginal project among said potential projects; and
adjusting at least one of said constraints to select a subset of said potential projects for said allocation of said capital such that a return on said capital is optimized.

15. The method of claim 14, further comprising measuring said return on said capital with at least one of net present value, cash flow return on investment, profitability index, revenue, operating income, and earnings before interest, taxes, depreciation, and amortization.

16. The method of claim 14, further comprising including at least one of said marginal projects within said subset of said potential projects selected for said allocation of said capital.

17. The method of claim 14, further comprising:
generating a sensitivity value for each of said constraints based on said identification of said marginal projects; and
adjusting said at least one of said constraints in accordance with at least one of said sensitivity values.

18. The method of claim 14, further comprising selecting another distinct subset of said potential projects for said allocation of said capital such that said return on said capital is optimized.

19. The method of claim 18, further comprising generating one or more reports configured to facilitate comparison of said subsets of said potential projects selected for said allocation of said capital.

20. The method of claim 14, wherein said organization comprises a plurality of business units each corresponding to at least one of said potential projects.

21. The method of claim 14, wherein two or more of said potential projects are dependent on one another.

22. A computer-readable medium including instructions configured to direct a computer to:
analyze project data corresponding to a plurality of potential projects within an organization;
facilitate input of one or more constraints on allocation of capital among said potential projects;
use said constraints to determine at least one marginal project among said potential projects; and
adjust at least one of said constraints to select a subset of said potential projects for said allocation of said capital such that a return on said capital is optimized.

23. The computer-readable medium of claim 22, wherein said instructions are further configured to direct said computer to include at least one of said marginal projects within said subset of said potential projects selected for said allocation of said capital.

24. The computer-readable medium of claim 23, wherein said instructions are further configured to direct said computer to:
generate a sensitivity value for each of said constraints based on said identification of said marginal projects; and
adjust said at least one of said constraints in accordance with at least one of said sensitivity values.
